(19) United States
(12) Patent Application Publication
(10) Pub. No.: US 2009/0056770 A1
(43) Pub. Date: Mar. 5, 2009

(54) Cleaning arrangement for toothbrushes with vibration and filter

(75) Inventor: Gabriel Uggla, Huddinge (SE)

Correspondence Address: YOUNG & THOMPSON, 209 Madison Street, Suite 500, ALEXANDRIA, VA, 22314, US

(73) Assignee: IGINIC HB, Huddinge (SE)

(21) Appl. No.: 11/665,767

(22) PCT Filed: Oct. 12, 2005
(86) PCT No.: PCT/SE2005/001516

§ 371 Date: Aug. 22, 2007

(30) Foreign Application Priority Data
Oct. 19, 2004 (SE) 0402521-9

(51) Int. Cl. B08B 3/00

(52) U.S. Cl. 134/110

(57) ABSTRACT

A cleaning arrangement (1) for toothbrushes (2) with a container (6) attached to the cleaning arrangement (1), where the container (6) is arranged to contain a cleaning fluid where the cleaning arrangement (1) is caused to clean the toothbrushes (2) from residual matter. The invention is characterised in that the container (6) in which the toothbrush is placed is arranged to vibrate, and in that a filter (11) is arranged essentially at the bottom of the container (6) in order to retain released residual matter released from the toothbrush at the bottom of the container (6).

The present invention relates to an arrangement for cleaning toothbrushes.

Toothbrushes are currently used every day by people all around the world. The function of the toothbrush together with toothpaste is at least one of to clean teeth from residual food and to freshen the mouth and breath of a person.

When the teeth are brushed clean with the toothbrush, saliva, residual food and residual toothpaste are transferred from the teeth to the toothbrush, something that can be reduced by the toothbrush being cleaned after brushing the teeth with water and, for example, a finger or a fingernail. A part of this residual matter, however, remains on the toothbrush and is incremented each time the toothbrush is used. Toothbrushes are generally used for a relatively long period and are used repeatedly, and thus a toothbrush full of residual matter and stored bacteria is placed into the mouth of a person.

Arrangements are currently available, however, that can remove this residual matter from the toothbrush and disinfect it. These arrangements use ultraviolet light, ultrasound, ozone or oxygen gas, and are used for the cleaning of a toothbrush, several toothbrushes, toothbrushes in combination with, for example, the cleaning of a razor or hairbrush, and possibly provide the possibility of using the arrangement for other surfaces in the bathroom, such as around the lavatory and the shower. Furthermore, arrangements are available that use the spraying of a fluid onto the toothbrush.

The disinfection most commonly involves the toothbrush being exposed to steam followed by the drying of the toothbrush.

It may feel unpleasant and unhygienic for certain persons to use a cleaning arrangement that is also used for the cleaning of other peoples' toothbrushes, even more so to use an arrangement that is also used for the cleaning of other items such as razors and hairbrushes, and even more so to use an arrangement that is used for the cleaning of other surfaces in the bathroom, such as around the lavatory and the shower.

Many of these arrangements are large relative to their purpose, they are driven by motors and have complex designs that require connection to a mains power supply, they are expensive for an individual consumer to purchase relative to what the cost of purchasing a new toothbrush when the previous one is worn out. Furthermore, certain arrangements within the prior art require a large volume of fluid such as a tooth-rinsing fluid or a disinfecting fluid, at each cleaning operation.

DE 100 61 927 A1 describes a cleaning arrangement for toothbrushes comprising a container into which toothbrushes are placed during their cleaning. A fluid is sprayed towards the toothbrushes, possibly in combination with the transmission of UV light, ultrasound or ozone through the fluid, such that the residual matter is to be shaken off from the toothbrush and into the fluid. The ultrasound may as an alternative be replaced in this patent by vibration, which means that vibrational waves may be transmitted through the fluid instead. One problem with this solution is that the residual matter when removed from the toothbrush remains circulating in the fluid in which the toothbrushes have been placed. This means that there is a great risk that the residual matter will again be placed onto the toothbrushes including the bristles of the toothbrush, or that it remains on the surfaces of the container when the fluid is released from the container, and is then mixed with and circulates around in the fluid that is used on the next occasion when cleaning of toothbrushes is to be carried out.

The aim of the present invention is to clean one toothbrush at a time in a simple and efficient manner.

The present invention thus relates to a cleaning arrangement for toothbrushes with a container fixed in the cleaning arrangement, where the container is arranged to receive a cleaning fluid and in which cleaning fluid is arranged to clean residual matter from the toothbrushes, and it is characterised in that the container is caused to vibrate, and in that a filter is arranged essentially at the bottom of the container in order to retain liberated residual matter at the bottom of the container.

The invention is described in more detail below, partly in association with the embodiments of the invention shown in attached drawings,

where

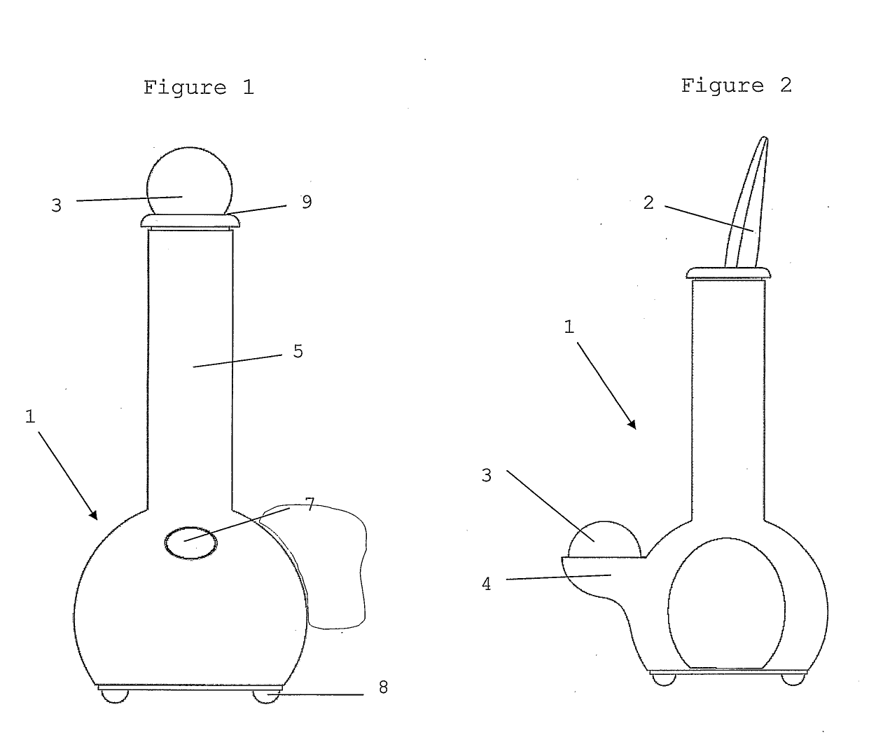

FIG. 1 shows schematically a frontal view of a cleaning arrangement with a protective ball closing the cleaning arrangement,

FIG. 2 shows the cleaning arrangement from the side with the protective ball removed from its location according to FIG. 1, and with a toothbrush inserted into the cleaning arrangement,

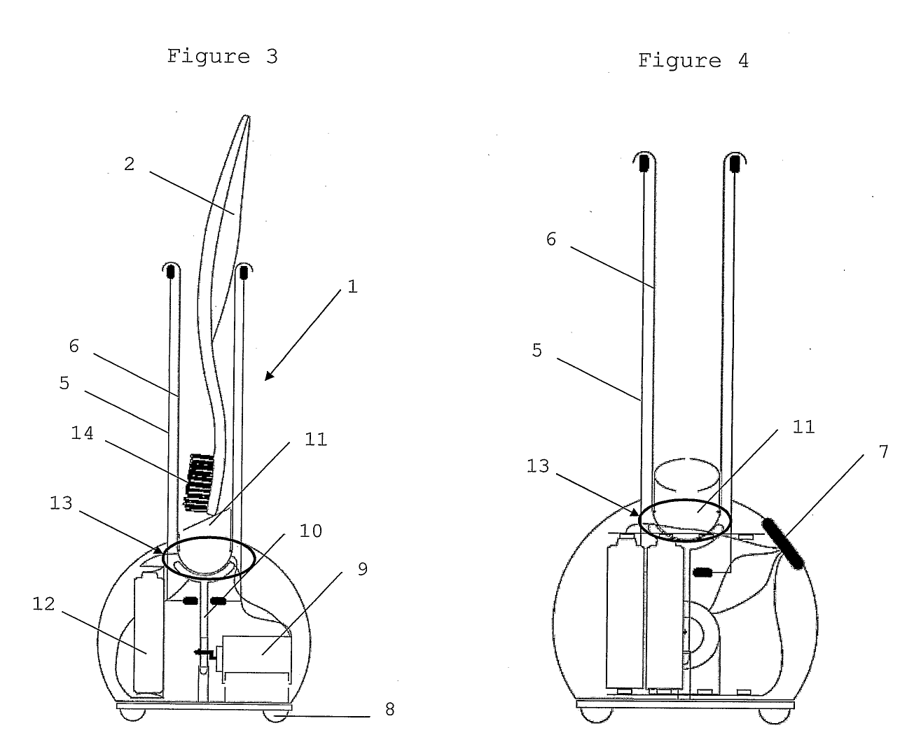

FIG. 3 shows a frontal view in cross section of the cleaning arrangement from FIGS. 1 and 2, and

FIG. 4 shows a cross section of the cleaning arrangement from the side.

The present invention concerns a cleaning arrangement 1 for toothbrushes 2 with a container 6 attached in the cleaning arrangement 1. The container 6 is arranged to receive a cleaning fluid in which the cleaning arrangement 1 is caused to clean residual matter from the toothbrushes 2.

The container 6 is, according to the invention, caused to vibrate, and a filter 11 is arranged essentially at the bottom of the container 6 in order to retain released residual matter at the bottom of the container 6.

FIG. 1 shows the cleaning arrangement 1 from the front. The arrangement 1 can have any one of several appearances, of which this is one suitable appearance. A protective ball 3 can be placed on top of the opening 9 of a tube-shaped part 5 of the cleaning arrangement 1. The protective ball 3 protects in this way the cleaning arrangement 1 from, for example, particles outside of the arrangement 1. A switch 7 is located on the arrangement 1, preferably located such that the arrangement is stable when the arrangement 1 is caused to be used by pressing in the switch 7. The cleaning arrangement 1 is provided with feet 8, which consist of a material that gives a high level of friction between the feet 8 and the surface on which the cleaning arrangement 1 is placed in order to reduce to a minimum sliding of the cleaning arrangement 1 on the support, where the feet further contribute to the cleaning arrangement 1 standing stably. A ball holder 4 can support the protective ball 3 when the arrangement 1 is in use, as shown in FIG. 2, and the toothbrush 2 can be placed into the cleaning arrangement 1 with the bristles 14 of the toothbrush 2 downwards.

The container 6 can have any design at all, limited only by the need for providing space for the toothbrush 2. The container 6 is placed into the cleaning arrangement 1, within the tube-shaped part 5, as shown in FIGS. 3 and 4. According to one preferred design, the container can be removed from the cleaning arrangement 1. Removal of the container 6 can take place in a manner that is easy and an efficient use of time.

It is desirable that the volume of fluid in the container, after the placing of the toothbrush 2 into it, is as small as possible in order to reduce to a minimum the consumption of cleaning fluid, such as salt solution, mouth-rinsing fluid and disinfectant fluid. According to one preferred design, the container 6 has the form of a tube. The tube can be constructed from any material at all, preferably a hygienic material that resists shaking and a material from whose surface residual matter can be easily rinsed away.

According to one preferred embodiment, the tube is arranged with a constriction 13 at the lower end of the tube. The term “lower end” is here used to denote what is the “lower end” when the cleaning arrangement 1 has been placed as shown in FIGS. 3 and 4.

Furthermore, the filter 11 is preferably arranged such that it is located at the constriction 13 at the lower end of the tube. The diameter of the filter 11 is preferably adapted for the diameter of the tube such that the filter 11 essentially occupies the complete cross-sectional area of the tube. The filter 11 is in this way located at the restriction 13 at the lower end of the tube since the diameter of the tube is there smaller than the diameter of the filter 11.

According to one preferred embodiment, the filter 11 is arranged to allow residual matter to pass the filter in one direction but not in the opposite direction. This means that the residual matter from tooth brushing will sink through the fluid onto the upper surface of the filter 11 and thereafter the residual matter can be allowed to pass through or past the filter 11 down to the constriction 13 in the tube. It will thus be possible in this manner for the residual matter to collect at the constriction 13 of the tube.

It is desirable that a hole, not shown in the drawings, is arranged at the filter 11 in order to facilitate the placing of the filter 11 at the bottom of the container 6. The hole should be of a size through which no residual matter can pass upwards through the container 6.

In one embodiment, the filter 11 is designed with an oblique upper surface which means that a larger area of filter is available through which the residual matter can pass.

As can be seen in FIGS. 3 and 4, the container 6 is located within the tube-shaped section 5, in contact with a support 10, which should be so designed that the container 6 is arranged to make contact with the support 10. The support 10 is connected to a motor 9. The motor 9 develops vibration of the support 10, where the vibration may be developed by, for example, the motor being unbalanced. The motor 9 is connected to the switch 7, which is connected to batteries 12.

When it is desired to use the cleaning arrangement 1, the switch 7 is depressed and this connects the battery or batteries 12 to the motor 9, which is in this way started. Thus, the support 10 vibrates and the container 6 is caused to vibrate mechanically.

The toothbrush 2 can be placed at any location in the fluid in the container 6, it is preferable that the toothbrush 2 be placed during cleaning in the container 6 with the bristles 14 of the toothbrush 2 located next to the filter 11, preferably at a distance of 0-10 cm, more preferably at a distance of 0-5 cm, and even more preferably at a distance of 0-2 cm from the filter, and most preferably are the bristles 14 of the toothbrush 2 placed in contact with the upper surface of the filter 11. Residual matter that is released from the toothbrush will in this way be able to fall essentially immediately onto the upper surface of the filter 11, fall through the filter 11 and collect under the filter 11 at the constriction 13 of the container 6. The residual matter can thus not be mixed around in the fluid into which the toothbrush has been inserted.

After the cleaning arrangement 1 has been used and the toothbrush removed from the arrangement 1, the container 6 can be removed from the arrangement 1, the fluid poured out from the container 6 while at the same time the filter 11 accompanies the fluid. The container 6 and the filter 11 can subsequently be rinsed clean of the residual matter in a simple and rapid manner in order subsequently to be replaced in the arrangement 1, which is thus ready to be used again.

A number of embodiments have been described above. However, the cleaning arrangement 1 with the container 6 comprising its constriction 13 and the filter 11, together with the causing of the container 6 to vibrate, can be designed in another suitable manner without deviating from the fundamental idea of the invention.

The present invention is thus not limited to the embodiments specified above. It can be varied within the framework specified by the attached patent claims.

1. A cleaning arrangement (1) for toothbrushes (2) with a container (6) attached to the cleaning arrangement (1), where the container (6) is arranged to contain a cleaning fluid where the cleaning arrangement (1) is caused to clean the toothbrushes (2) from residual matter, characterised in that the container (6) in which the toothbrush is placed is arranged to vibrate, and in that a filter (11) is arranged essentially at the bottom of the container (6) in order to retain residual matter released from the toothbrush at the bottom of the container (6).

2. The cleaning arrangement (1) according to claim 1, characterised in that the container (6) can be removed.

3. The cleaning arrangement (1) according to claim 1, characterised in that the container (6) has the form of a tube.

4. The cleaning arrangement (1) according to claim 3, characterised in that the tube is arranged with a constriction (13) at its lower end.

5. The cleaning arrangement (1) according to claim 4, characterised in that the filter (11) is arranged such that it is located at the constriction (13) at the lower end of the tube.

6. The cleaning arrangement (1) according to claim 1, characterised in that the filter (11) is arranged such that it allows residual matter to pass the filter (11) in one direction but not in the opposite direction.

7. The cleaning arrangement (1) according to claim 1, characterised in that the filter (11) is arranged with a hole in order to facilitate the location of the filter (11) at the bottom of the container (6).

8. The cleaning arrangement (1) according to claim 1, characterised in that the container (6) is caused to vibrate mechanically.

9. The cleaning arrangement (1) according to claim 1, characterised in that the toothbrush (2) is located in the container (6) during cleaning with the bristles (14) of the toothbrush (2) located close to the filter (11).

10. The cleaning arrangement (1) according to claim 2, characterised in that the container (6) has the form of a tube.
